(19) United States
(12) Patent Application Publication
(10) Pub. No.: US 2018/0032482 A1
(43) Pub. Date: Feb. 1, 2018

(54) DOCUMENT DISPLAY DEVICE AND METHOD

(71) Applicant: AIRBUS (S.A.S.), Toulouse (FR)

(72) Inventors: Jaouad BERRAJAA, PLAISANCE DU TOUCH (FR); Joel DUFOUR, BRAX (FR)

(21) Appl. No.: 15/658,170

(22) Filed: Jul. 24, 2017

(30) Foreign Application Priority Data
Jul. 28, 2016 (FR) 16 57267

(51) Int. Cl. G06F 17/21; G06T 11/60; G06F 17/22

(52) U.S. Cl. CPC G06F 17/212; G06F 17/2205; G06T 11/60

(57) ABSTRACT

A device for displaying a document includes a display screen, a human-machine interface, a first memory zone and at least one second memory zone separate from the first memory zone. The zones are configured to contain similar information. A processor is configured to execute a first process and at least one second process when a display request is received via the human-machine interface. Those processes include respectively reading first information in the first memory zone and second information in the second memory zone. That information corresponds to the display request. The processes also include respectively producing a first display layer and a second display layer associated with the display screen, the first display layer and the second display layer being displayed on the display screen superimposed.

### CROSS-REFERENCE TO RELATED APPLICATION

This patent application claims the benefit of and priority to French patent application number 16 57267 filed on Jul. 28, 2016, the entire disclosure of which is incorporated by reference herein.

### TECHNICAL FIELD

The disclosure herein relates to the field of the display of a document on a display device, in particular in a cockpit of an aircraft.

### BACKGROUND

Aircraft are delivered to user airlines with documentation enabling the use of the aircraft. This documentation generally includes a set of manuals including an airplane flight manual (AFM), a flight crew operating manual (FCOM), a flight crew techniques manual (FCTM) and a quick reference handbook (QRH). Until a few years ago, these various manuals were delivered in paper form. In order to reduce their weight, with the exception of the quick reference handbook QRH, these manuals are now delivered in the form of electronic files, in particular files that can be consulted by a laptop computer, a touch-screen tablet or a display screen of the cockpit of the aircraft. The quick reference handbook QRH is still delivered in paper form, however. In effect, this manual is used on board the aircraft by a single crew member, in contrast to the other manuals that are used by two crew members each equipped with an electronic device such as a laptop computer or a touch-screen tablet. Now, the air safety authorities require that the display of the manuals on an electronic device of this kind allows the detection of a display error by the crew members when the use by a crew member of the information displayed on an electronic device of this kind is liable to be of a critical nature for the flight of the aircraft. Where the manuals used by two crew members are concerned, the detection of display errors can rely on cross-verification of the information displayed on those electronic devices. On the other hand, where the quick reference handbook QRH is concerned, in that it is used by only one crew member, cross-verification of this kind is not possible. There is therefore a requirement for a solution enabling use of a display of the quick reference handbook QRH on an electronic device at the same time as satisfying the requirements of the air safety authorities.

### SUMMARY

An object of the present disclosure is to provide a solution to the above problems. The present disclosure concerns a device for displaying a document, the device including:

a display screen;

a human-machine interface;

a first memory zone; and

a processor configured to execute a first process when a display request is received via the human-machine interface, that first process comprising:
reading first information corresponding to the display request in the first memory zone; and
producing a first display layer associated with the display screen as a function of the first information.
   This device is noteworthy in that it further includes at least one second memory zone separate from the first memory zone, the first memory zone and the second memory zone being configured to contain similar information, and the processor is further configured to execute at least one second process when the display request is received via the human-machine interface, that second process comprising:
reading second information corresponding to the display request in the second memory zone; and
producing a second display layer associated with the display screen as a function of the second information,
   the first display layer and the second display layer being displayed on the display screen superimposed.

Accordingly, if a display error occurs on one of the display layers, the display on the screen is then incoherent because it is the result of the superimposition of at least two different display layers. The user of the display device can therefore see that the display on the screen is incoherent. This enables them to realise that they must not trust the information displayed on the screen. On the other hand, if the display on the screen is coherent, that display is the result of the superimposition of identical display layers and the user can trust the information displayed on the screen. The display device therefore enables a user to detect a display error and therefore to tell whether they can trust the information displayed on the screen or not.

According to a first alternative, the first memory zone and the second memory zone correspond to two separate address zones of a same physical memory.

According to a second alternative, the first memory zone and the second memory zone correspond to two distinct physical memories.

According to a third alternative, the display device being connected to a communication network to which are also connected a first server and a second server, the first memory zone corresponds to a memory zone of the first server and the second memory zone corresponds to a memory zone of the second server.

According to a first variant, the first process and the second process are similar.

According to a second variant, the first process and the second process correspond to software functions coded differently.

In one embodiment, the first process and the second process are synchronous.

In another embodiment, the first process and the second process are asynchronous.

The processor is advantageously configured to verify the correspondence of the information contained in the first memory zone and the information contained in the second memory zone before consultation of the document by a user.

The disclosure herein also relates to a method of displaying a document on a display device, the display device including:

a display screen;

a human-machine interface;

a first memory zone; and

a processor,

the method including the execution of a first process by the processor when a display request is received via the human-machine interface, that first process comprising:
reading first information corresponding to the display request in the first memory zone; and
producing a first display layer associated with the display screen as a function of the first information.
   This method is noteworthy in that, the display device further including at least one second memory zone separate from the first memory zone, the first memory zone and the second memory zone being configured to contain similar information, the method includes the execution of a second process by the processor when the display request is received via the human-machine interface, that second process comprising:
reading second information corresponding to the display request in the second memory zone; and
producing a second display layer associated with the display screen as a function of the second information,
   the first display layer and the second display layer being displayed on the display screen superimposed.

### BRIEF DESCRIPTION OF THE DRAWINGS

The disclosure herein will be better understood on reading the following description and examining the appended example figures or drawings.

FIG. 1 is a schematic representation of a display device according to one embodiment of the disclosure herein.

FIG. 2 shows an example of a display on a display device according to one embodiment of the disclosure herein.

### DETAILED DESCRIPTION

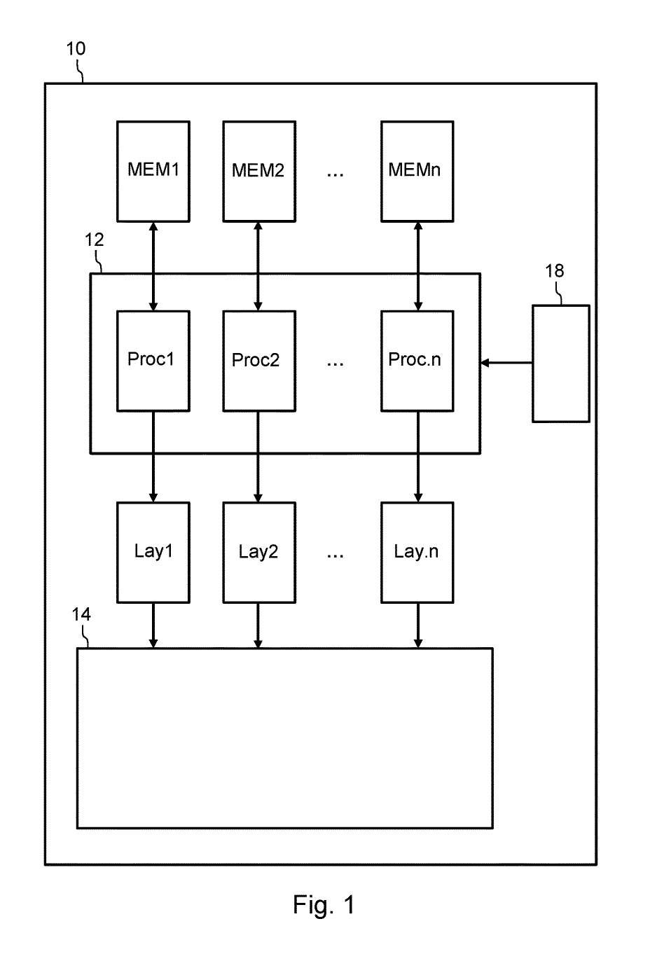

The display device 10 shown in FIG. 1 includes a set of memory zones MEM1, MEM2 . . . MEMn that are separate from one another. The various memory zones are configured to contain similar information. The display device also includes a processor 12 (including in particular a microprocessor or a microcontroller) and a display screen 14 with which are associated display layers Lay1, Lay2 . . . Lay.n. These display layers correspond for example to memory zones defined in a display memory associated with the display screen or in a memory of the display device 10. The display device also includes a human-machine interface 18 connected to the processor 12. In a first example, this human-machine interface is a mouse and/or a keyboard; in a second example, it corresponds to a touch-sensitive surface of the display screen 14. The number n of memory zones and of display layers is an integer greater than or equal to 2. For greater convenience, the remainder of the description is based on a number n equal to 2 without this limiting the number of memory zones and of display layers of the display device 10.

In use, when a user requests the display of a part of a document by submitting a display request by the human-machine interface 18 that receives that request, the human-machine interface transmits that request to the processor 12. The processor 12 then executes a first process Proc1 comprising:
reading first information corresponding to the display request in the first memory zone MEM1; and
producing a first display layer Lay1 associated with the display screen 14 as a function of the first information.

The processor also executes a second process Proc2 comprising:
reading second information corresponding to the display request in the second memory zone MEM2; and
producing a second display layer Lay2 associated with the display screen as a function of the second information.
   The first display layer Lay1 and the second display layer Lay2 are displayed on the display screen superimposed. The background of each of the layers is considered transparent so as to enable the superimposition of the various layers on the display screen 14.

The two redundant processes Proc1 and Proc2 therefore produce two display layers Lay1 and Lay2 independently on the basis of information stored in the memory zones MEM1 and MEM2, respectively. These two display layers are superimposed on the display screen 14. Thus, if an error occurs in one of the memory zones MEM1 or MEM2 in the processing of the information by one of the processes Proc1 or Proc2, or even in a memory used to store one of the display layers Lay1 or Lay2, the two display layers are then different and their superimposition produces an incoherent display. The user of the display device 10 can then readily see that this display is incoherent, which dissuades them from taking it into account.

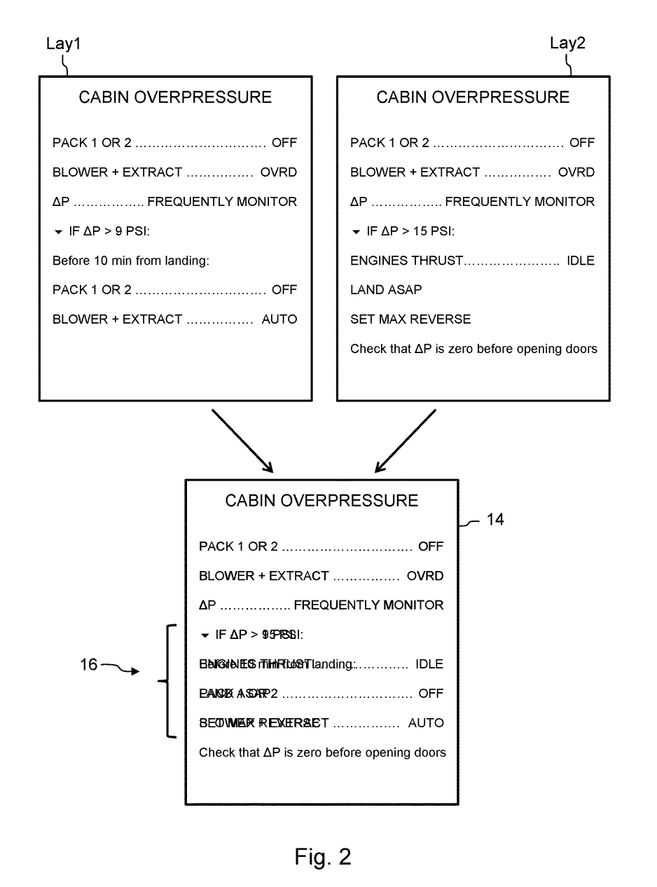

In the example illustrated by FIG. 2, the lower part of the display corresponding to the second layer Lay2 is different from the lower part of the first layer Lay1. The resulting display, on the display screen 14 of the superimposition of the first and second layers is incoherent for a set of lines 16, which enables a user to become aware of a display problem.

According to a first alternative, the various memory zones MEM1, MEM2 . . . MEMn are defined in a same physical memory, for example a memory (integrated circuit) of the processor 12 or even a memory card connected to the processor 12. The various memory zones then correspond to separate address zones of the physical memory. In the event of failure of a cell or of a set of memory cells of a memory zone, the failure of the corresponding cells of another memory zone is relatively improbable. This enables different display layers to be produced in the case of such a failure and therefore enables that failure to be detected.

According to a second alternative, the various memory zones MEM1, MEM2 . . . MEMn correspond to distinct physical memories. Those distinct physical memories correspond for example to a plurality of memories (integrated circuits) of the processor 12 or even to a plurality of memory cards connected to the processor 12. In the event of failure of a cell or of a set of memory cells of a memory, failure of the corresponding cells of another memory is relatively improbable. This enables different display layers to be produced in the case of such a failure and therefore enables that failure to be detected.

According to a third alternative, the display device 10 is connected to a communication network to which a plurality of servers are also connected. The various memory zones MEM1, MEM2 . . . MEMn are then defined in the various servers. In the event of failure of a cell or of a set of memory cells on a server, failure of the corresponding cells on another server is relatively improbable. This enables different display layers to be produced in the case of such a failure and therefore enables that failure to be detected.

According to a first variant, the various processes Proc1, Proc2 . . . Proc.n are similar. They correspond for example to a plurality of instances of a same software function. It is relatively improbable that a problem such as an electrical interference for example will be able to disturb these different instances of the software function in a similar manner. As a result of this, the various instances of the software function then produce different display layers, which enables detection of a display problem. It is considered here that the software function has been tested and validated with a sufficient quality assurance level. The objective is not to detect a problem with the programming of the software function, but rather an execution problem, such as for example the aforementioned electrical interference.

According to a second variant, the various processes Proc1, Proc2 . . . Proc.n correspond to software functions coded in at least two different ways. In addition to the detection of an execution problem, as in the first variant, this second variant further enables detection of different behavior of the various software functions, caused for example by a programming problem.

In one embodiment, the various processes Proc1, Proc2 . . . Proc.n are synchronous. They are then executed concomitantly in a real-time computing environment, for example.

In another embodiment, the various processes Proc1, Proc2 . . . Proc.n are asynchronous. They are executed sequentially for example. This enables faster production and display of a first display layer.

The different display layers advantageously correspond to different display colours. For example, in the case of two display layers Lay1 and Lay2 as shown in FIG. 2, the first display layer Lay1 is displayed in black in the foreground and the second display layer is displayed in red in the background. In the absence of any difference between the two display layers, the first layer therefore completely masks the display of the second layer and the resulting display on the display screen 14 is entirely black. On the other hand, if there is a difference between the two display layers, at least a part of the second display layer can be seen on the display screen 14. Consequently, the display screen 14 includes at least a part in red, which enables a user to detect a display problem more easily.

More advantageously, the processor is configured to verify the correspondence of the information contained in the various memory zones MEM1, MEM2 . . . MEMn before consultation of the document by a user. In a first embodiment, the processor 12 verifies the correspondence of the information following loading of the information into the various memory zones. For example, the display device 10 includes a communication port (notably of USB® type, Ethernet type, WiFi® type, etc.) and a user connects to that communication port a device (such as a USB key, a laptop computer, etc.) containing previously validated information corresponding to one or more documents that can be displayed by the display device 10. The user then configures the display device 10 in an operating mode allowing the loading of the information. When the loading of the information into the various memory zones is finished, the processor executes a process, for example a software function, to compare the information stored in the various memory zones so as to verify the correspondence of the information stored in the various memory zones. In the event of a difference between the information stored in the various memory zones, the processor signals an error to the user. In a second embodiment, which may be combined with the first embodiment, the processor verifies the correspondence of the information contained in the various memory zones on starting up the display device 10. According to a first variant, this starting up of the display device 10 corresponds to the starting up of an operating system of the display device 10; according to a second variant, this starting up corresponds to the starting up of a software application designed to enable consultation of the document or documents stored in the various memory zones.

In one embodiment, the display device 10 is used in an aircraft cockpit and corresponds to a laptop computer of electronic flight bag (EFB) type. In particular, one document stored in the display device 10 is a quick reference handbook QRH. The information stored in the various memory zones MEM1, MEM2 . . . MEMn is information relating to this quick reference handbook QRH.

The subject matter disclosed herein can be implemented in or with software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for displaying a document, the device comprising:
a display screen;
a human-machine interface;
a first memory zone; and
a processor configured to execute a first process when a display request is received via the human-machine interface, the first process comprising:
reading first information corresponding to the display request in the first memory zone; and
producing a first display layer associated with the display screen as a function of the first information;
the device further comprising at least one second memory zone separate from the first memory zone, the first memory zone and the second memory zone being configured to contain similar information, and wherein the processor is further configured to execute at least one second process when the display request is received via the human-machine interface, the second process comprising:
reading second information corresponding to the display request in the second memory zone; and
producing a second display layer associated with the display screen as a function of the second information,
the first display layer and the second display layer being displayed on the display screen superimposed.

2. The display device according to claim 1, wherein the first memory zone and the second memory zone correspond to two separate address zones of the same physical memory.

3. The display device according to claim 1, wherein the first memory zone and the second memory zone correspond to two distinct physical memories.

4. The display device according to claim 1, wherein the display device is connected to a communication network to which are also connected a first server and a second server, the first memory zone corresponding to a memory zone of the first server and the second memory zone corresponding to a memory zone of the second server.

5. The display device according to claim 1, wherein the first process and the second process are similar.

6. The display device according to claim 1, wherein the first process and the second process correspond to software functions coded differently.

7. The display device according to claim 1, wherein the first process and the second process are synchronous.

8. The display device according claim 1, wherein the first process and the second process are asynchronous.

9. The display device according to claim 1, wherein the processor is configured to verify correspondence of information contained in the first memory zone and information contained in the second memory zone before consultation of the document by a user.

10. The display device according to claim 1, wherein information stored in the first memory zone and in the at least one second memory zone relates to a quick reference handbook QRH of an aircraft.

11. A method of displaying a document on a display device, the display device comprising:
a display screen;
a human-machine interface;
a first memory zone; and
a processor;
the method comprising execution of a first process by the processor when a display request is received via the human-machine interface, the first process comprising:
reading first information corresponding to the display request in the first memory zone; and
producing a first display layer associated with the display screen as a function of the first information,
the display device further comprising at least one second memory zone separate from the first memory zone, the first memory zone and the second memory zone being configured to contain similar information, the method comprising execution of a second process by the processor when the display request is received via the human-machine interface, the second process comprising:
reading second information corresponding to the display request in the second memory zone; and
producing a second display layer associated with the display screen as a function of the second information,
the first display layer and the second display layer being displayed on the display screen superimposed.
